(19) United States
(12) Patent Application Publication
(10) Pub. No.: US 2014/0375538 A1
(43) Pub. Date: Dec. 25, 2014

(54) DISPLAY APPARATUS INCORPORATING CONSTRAINED LIGHT ABSORBING LAYERS

(71) Applicant: Pixtronix, Inc., San Diego, CA (US)

(72) Inventors: Jianru Shi, Haverhill, MA (US); Xiang-Dong Mi, Northborough, MA (US); Jignesh Gandhi, Burlington, MA (US)

(21) Appl. No.: 13/921,980

(22) Filed: Jun. 19, 2013

(51) Int. Cl. G02B 26/02

(52) U.S. Cl. CPC G02B 26/02
USPC 345/156; 359/230; 345/501; 427/97.4

(57) ABSTRACT

This disclosure provides systems, methods and apparatus for modulating light for a display. The system includes a light blocking layer including a reflective layer and a light absorbing layer. The light blocking layer is configured such that any conductive components therein underlie or cover less than a majority of the circuitry controlling the display elements incorporated into the display.

### TECHNICAL FIELD

This disclosure relates to the field of displays, and in particular, to light blocking layers incorporated into displays.

### DESCRIPTION OF THE RELATED TECHNOLOGY

Electromechanical systems (EMS) devices include devices having electrical and mechanical elements, such as actuators, optical components (such as mirrors, shutters, and/or optical film layers) and electronics. EMS devices can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of deposited material layers, or that add layers to form electrical and electromechanical devices.

EMS-based display apparatus have been proposed that include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus that includes a substrate, a plurality of display elements, and a light blocking layer. The substrate includes a display region and a periphery. The plurality of display elements are arranged across the display region of the substrate. Each display element includes at least one movable component supported a first distance over the substrate. The movement of the movable components are controlled in part by respective switches coupled to the substrate. The light blocking layer is disposed between the display elements and the substrate and defines a plurality of apertures therethrough. The light blocking layer includes a light absorbing layer patterned such that it substantially surrounds each of the apertures by a width that is greater than or about equal to the first distance and less than about 5 times the first distance. In some implementations, the apparatus further includes a coversheet coupled to the substrate along the periphery of the substrate, and the coversheet forms the front of the apparatus.

In some implementations, the light blocking layer further includes a non-conductive light reflecting layer extending across substantially the entirety of display region other than at the apertures defined through the light blocking layer. In some implementations, the non-conductive light reflecting layer can include a dielectric mirror.

In some implementations, the light absorbing layer includes at least one layer of conductive material. In some implementations, the light absorbing layer is absent above and below the switch. In some implementations, the light absorbing layer includes a multi-layer stack of a metal and one of a semiconductor and a dielectric. In some such implementations, the multi-layer stack includes at least one layer of a semiconductor having a thickness of less than about 50 nm. In some implementations, the multi-layer stack includes at least one layer of metal having a thickness of less than about 50 nm.

In some implementations, the light absorbing layer includes a first set of layers configured to absorb light incident on an external face of the substrate and a second set of layers configured to absorbing light incident on an internal face of the substrate. In some such implementations, the light absorbing layer includes layers of a metal and a dielectric, each having thicknesses of less than about 100 nm, on either side of a layer of metal having a thickness of greater than about 100 nm.

In some implementations, the apparatus further includes a display that includes the plurality of display elements, a processor configured to communicate with the display and to process image data, and a memory device that is configured to communicate with the processor. In some implementations, the apparatus also includes a driver circuit configured to send at least one signal to the display, and the processor is further configured to send at least a portion of the image data to the driver circuit. In some implementations, the apparatus includes an image source module configured to send the image data to the processor. The image source module can include at least one of a receiver, transceiver, and transmitter. In some implementations, the apparatus includes an input device configured to receive input data and to communicate the input data to the processor.

Another innovative aspect of the subject matter described in this disclosure can be implemented in an apparatus that includes a substrate, a plurality of display elements, and a light blocking layer. The substrate includes a display region and a periphery. The plurality of display elements are arranged across the display region of the substrate. Each display element includes at least one movable component supported over the substrate, which is controlled in part by circuitry coupled to the substrate. The light blocking layer is disposed between the display element and the substrate and defines a plurality of apertures therethrough. The light blocking layer can include a non-conductive light reflecting layer covering substantially the entirety of the display region of the substrate, other than at the apertures defined through the light blocking layer, and a light absorbing layer patterned such that it substantially surrounds each of the apertures defined through the light blocking layer, but which is absent between the substrate and the majority of the circuitry.

In some implementations, the movable components of the display elements are supported a first distance over the light blocking layer, and the light absorbing layer has a width around each of the apertures which is greater than or about equal to the first distance. In some implementations, the width is less than about five times the first distance. In some implementations, the non-conductive light reflecting layer comprises a dielectric mirror. In some implementations, the light absorbing layer includes a conductive material. In some implementations, the light absorbing layer includes a multi-layer stack of a metal and one of a semiconductor and a dielectric. In some implementations, the circuitry includes at least one thin-film transistor.

Another innovative aspect of the subject matter described in this disclosure can be implemented in a method of manufacturing. The method includes fabricating a reflective layer over a substrate, patterning the reflective layer to form apertures therethrough, and fabricating a light absorbing layer over the reflective layer. The method further includes patterning the light absorbing layer to form apertures therethrough and to constrain the light absorbing material to regions around the apertures. The method also includes fabricating a control matrix over the reflective layer and fabricating a plurality of light modulators over the control matrix, such that the light modulators correspond to respective apertures patterned through the reflective layer and the light absorbing layer.

In some implementations, the light modulators are separated from a front-facing surface of the light absorbing layer by a first distance, and the region the light absorbing material is constrained to extends less than about five times the first distance from the respective apertures. In some implementations, the reflective layer is fabricated to be non-conductive. In some implementations, the light absorbing layer is fabricated from a plurality of layers of material, including at least one conductive material. In some implementations, wherein the control matrix is fabricated substantially outside of the region to which the light absorbing material is constrained.

Details of one or more implementations of the subject matter described in this specification are set forth in the accompanying drawings and the description below. Although the examples provided in this summary are primarily described in terms of MEMS-based displays, the concepts provided herein may apply to other types of displays, such as liquid crystal displays (LCD), organic light emitting diode (OLED) displays, electrophoretic displays, and field emission displays, as well as to other non-display MEMS devices, such as MEMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIG. 2A shows a plan view of a portion of an example display apparatus.

FIG. 2B shows a cross sectional view of the display apparatus shown in FIG. 2A.

FIG. 3 is a cross sectional view of an example one-sided light absorbing material stack.

FIG. 4 shows a cross sectional view of an example two-sided light absorbing layer.

FIG. 5 shows a block diagram of an example method of manufacturing a display apparatus.

FIGS. 6 and 7 show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (such as e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Various display apparatus include arrays of display elements that modulate light passing through apertures formed in a light blocking layer. In some such implementations, the display elements and the circuitry used to control the display elements are formed on the same substrate that the light blocking layer is formed. If the light blocking layer is conductive, leaving the light blocking material over or under the circuitry that controls the display elements can create parasitic capacitances on the circuitry, resulting in increased power consumption from the display.

Light blocking layers in display apparatus can be fabricated such that any conductive components in the light blocking layers surround apertures formed through the light blocking layer, but such that they do not underlie or cover the majority of the circuitry that controls display elements in the display apparatus (referred to as a control matrix). As a result, the light blocking layer is able to improve the contrast ratio of the display without unduly increasing the power consumption requirements of the display. In some implementations, such conductive components form a light absorbing layer. In some implementations, the light blocking layer also includes a non-conductive light reflecting layer, which can underlie the control matrix.

Particular implementations of the subject matter described in this disclosure can be implemented to realize one or more of the following potential advantages. Forming a light blocking layer in a display that largely avoids any conductive materials that extend under or over circuitry limits parasitic capacitances on elements of the control matrix. Reducing such parasitic capacitances both reduces the power necessary to transmit signals through the control matrix as well as increases the signal propagation rate. This in turn results in a lower overall display power consumption level and allows for faster display addressing and actuation.

Moreover, by still providing a light absorbing layer that surrounds apertures formed in the light blocking layer, light reflecting off of various components within the display, such as the underside of a light-modulating shutter, can be absorbed prior to such light leaking out of the display. Absorbing this light can help improve the contrast ratio of the display, improving its image quality.

In some implementations, by fabricating the light absorbing layer from alternating layers of metal and a semiconductor or dielectric or conductive oxides, the light absorbing layer can achieve very high levels of light absorption. For example, the light absorbing layer can have a reflectance that is less than or equal to about 2%.

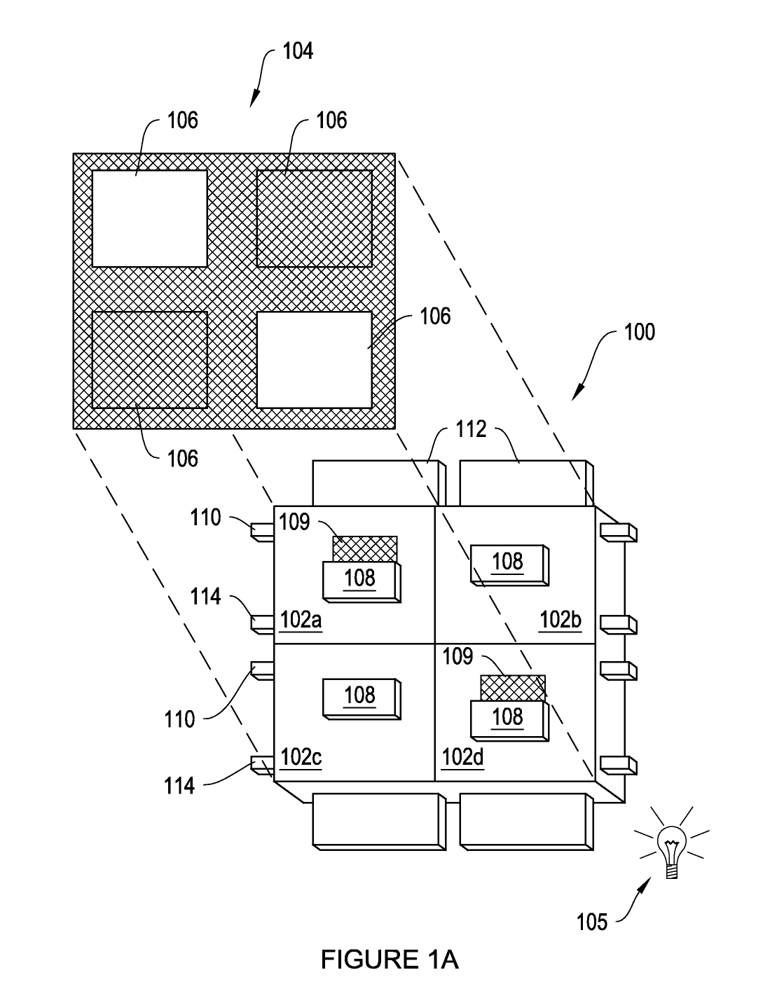

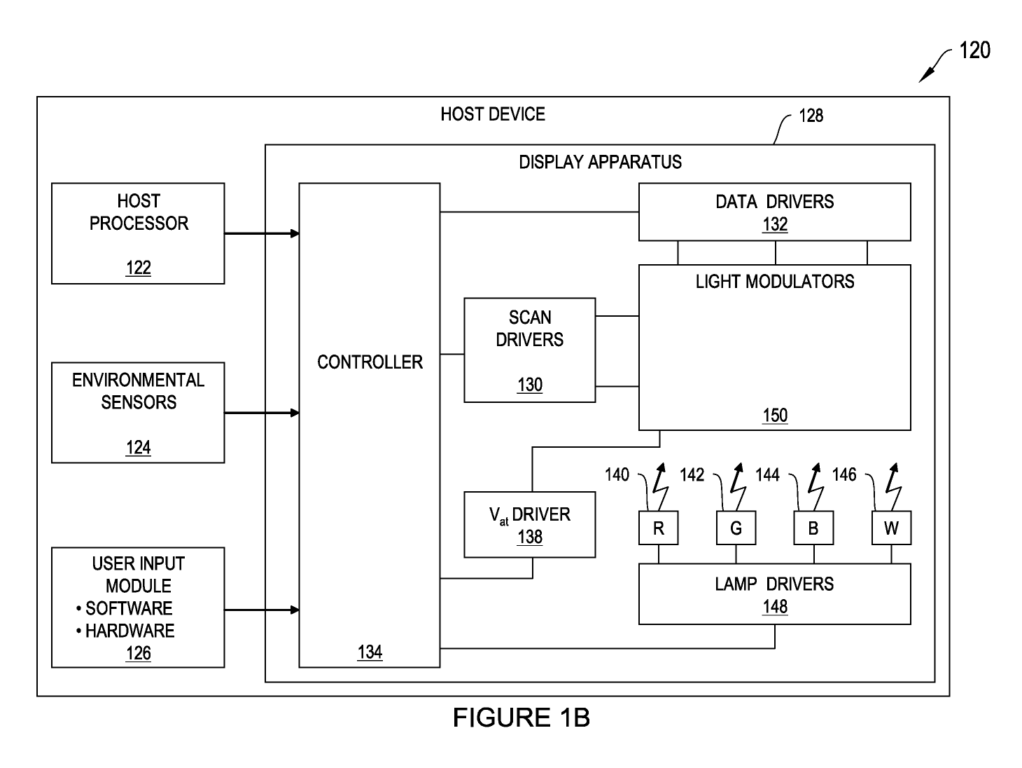

FIG. 1A shows a schematic diagram of an example direct-view MEMS-based display apparatus 100. The display apparatus 100 includes a plurality of light modulators 102a-102d (generally “light modulators 102”) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide luminance level in an image 104. With respect to an image, a “pixel” corresponds to the smallest picture element defined by the resolution of image. With respect to structural components of the display apparatus 100, the term “pixel” refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or “backlight” so that each pixel can be uniformly illuminated. Transmissive direct-view displays are often built onto transparent or glass substrates to facilitate a sandwich assembly arrangement where one substrate, containing the light modulators, is positioned directly on top of the backlight.

Each light modulator 102 can include a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (such as interconnects 110, 112 and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, V_{WE}”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B shows a block diagram of an example host device 120 (i.e., cell phone, smart phone, PDA, MP3 player, tablet, e-reader, netbook, notebook, etc.). The host device 120 includes a display apparatus 128, a host processor 122, environmental sensors 124, a user input module 126, and a power source.

The display apparatus 128 includes a plurality of scan drivers 130 (also referred to as “write enabling voltage sources”), a plurality of data drivers 132 (also referred to as “data voltage sources”), a controller 134, common drivers 138, lamps 140-146, lamp drivers 148 and an array 150 of display elements, such as the light modulators 102 shown in FIG. 1A. The scan drivers 130 apply write enabling voltages to scan-line interconnects 110. The data drivers 132 apply data voltages to the data interconnects 112.

In some implementations of the display apparatus, the data drivers 132 are configured to provide analog data voltages to the array 150 of display elements, especially where the luminance level of the image 104 is to be derived in analog fashion. In analog operation, the light modulators 102 are designed such that when a range of intermediate voltages is applied through the data interconnects 112, there results a range of intermediate open states in the shutters 108 and therefore a range of intermediate illumination states or luminance levels in the image 104. In other cases, the data drivers 132 are configured to apply only a reduced set of 2, 3 or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the “controller 134”). The controller sends data to the data drivers 132 in a mostly serial fashion, organized in predetermined sequences grouped by rows and by image frames. The data drivers 132 can include series to parallel data converters, level shifting, and for some applications digital to analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 114. In some other implementations, the common drivers 138, following commands from the controller 134, issue voltage pulses or signals to the array 150 of display elements, for instance global actuation pulses which are capable of driving and/or initiating simultaneous actuation of all display elements in multiple rows and columns of the array 150.

All of the drivers (such as scan drivers 130, data drivers 132 and common drivers 138) for different display functions are time-synchronized by the controller 134. Timing commands from the controller coordinate the illumination of red, green and blue and white lamps (140, 142, 144 and 146 respectively) via lamp drivers 148, the write-enabling and sequencing of specific rows within the array 150 of display elements, the output of voltages from the data drivers 132, and the output of voltages that provide for display element actuation. In some implementations, the lamps are light emitting diodes (LEDs).

The controller 134 determines the sequencing or addressing scheme by which each of the shutters 108 can be re-set to the illumination levels appropriate to a new image 104. New images 104 can be set at periodic intervals. For instance, for video displays, the color images 104 or frames of video are refreshed at frequencies ranging from 10 to 300 Hertz (Hz). In some implementations the setting of an image frame to the array 150 is synchronized with the illumination of the lamps 140, 142, 144 and 146 such that alternate image frames are illuminated with an alternating series of colors, such as red, green, and blue. The image frames for each respective color is referred to as a color subframe. In this method, referred to as the field sequential color method, if the color subframes are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, and blue.

In some implementations, where the display apparatus 100 is designed for the digital switching of shutters 108 between open and closed states, the controller 134 forms an image by the method of time division grayscale, as previously described. In some other implementations, the display apparatus 100 can provide grayscale through the use of multiple shutters 108 per pixel.

In some implementations, the data for an image state 104 is loaded by the controller 134 to the display element array 150 by a sequential addressing of individual rows, also referred to as scan lines. For each row or scan line in the sequence, the scan driver 130 applies a write-enable voltage to the write enable interconnect 110 for that row of the array 150, and subsequently the data driver 132 supplies data voltages, corresponding to desired shutter states, for each column in the selected row. This process repeats until data has been loaded for all rows in the array 150. In some implementations, the sequence of selected rows for data loading is linear, proceeding from top to bottom in the array 150. In some other implementations, the sequence of selected rows is pseudo-randomized, in order to minimize visual artifacts. And in some other implementations the sequencing is organized by blocks, where, for a block, the data for only a certain fraction of the image state 104 is loaded to the array 150, for instance by addressing only every 5^{th} row of the array 150 in sequence.

In some implementations, the process for loading image data to the array 150 is separated in time from the process of actuating the display elements in the array 150. In these implementations, the display element array 150 may include data memory elements for each display element in the array 150 and the control matrix may include a global actuation interconnect for carrying trigger signals, from common driver 138, to initiate simultaneous actuation of shutters 108 according to data stored in the memory elements.

In alternative implementations, the array 150 of display elements and the control matrix that controls the display elements may be arranged in configurations other than rectangular rows and columns. For example, the display elements can be arranged in hexagonal arrays or curvilinear rows and columns. In general, as used herein, the term scan-line shall refer to any plurality of display elements that share a scan-line interconnect.

The host processor 122 generally controls the operations of the host. For example, the host processor 122 may be a general or special purpose processor for controlling a portable electronic device. With respect to the display apparatus 128, included within the host device 120, the host processor 122 outputs image data as well as additional data about the host. Such information may include data from environmental sensors, such as ambient light or temperature; information about the host, including, for example, an operating mode of the host or the amount of power remaining in the host's power source; information about the content of the image data; information about the type of image data; and/or instructions for display apparatus for use in selecting an imaging mode.

The user input module 126 conveys the personal preferences of the user to the controller 134, either directly, or via the host processor 122. In some implementations, the user input module 126 is controlled by software in which the user programs personal preferences such as “deeper color,” “better contrast,” “lower power,” “increased brightness,” “sports,” “live action,” or “animation.” In some other implementations, these preferences are input to the host using hardware, such as a switch or dial. The plurality of data inputs to the controller 134 direct the controller to provide data to the various drivers 130, 132, 138 and 148 which correspond to optimal imaging characteristics.

An environmental sensor module 124 also can be included as part of the host device 120. The environmental sensor module 124 receives data about the ambient environment, such as temperature and or ambient lighting conditions. The sensor module 124 can be programmed to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

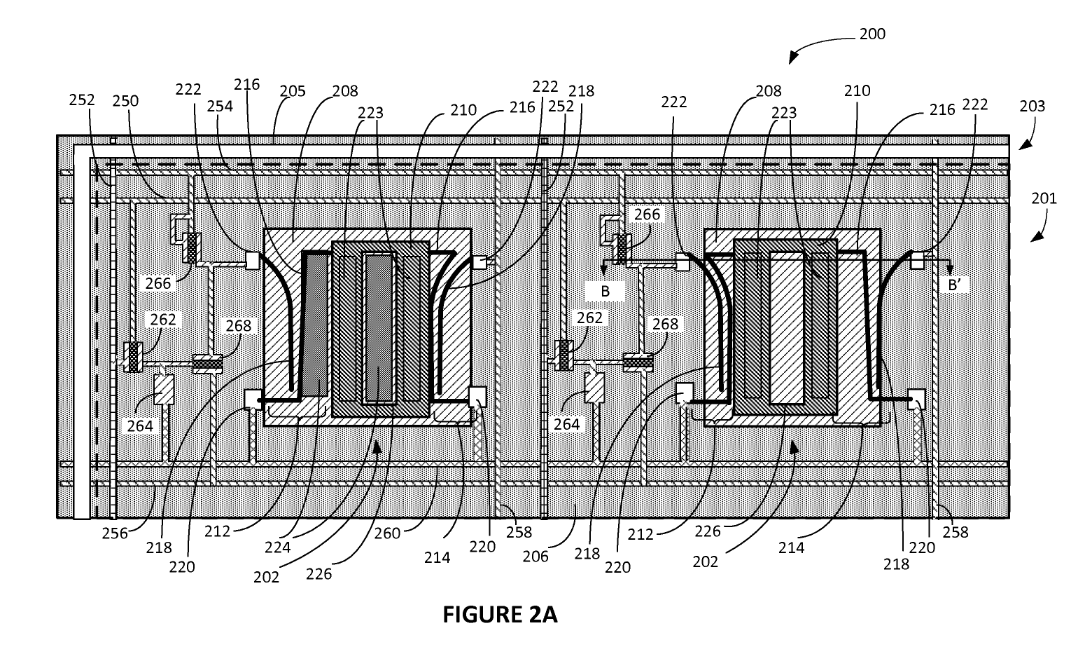

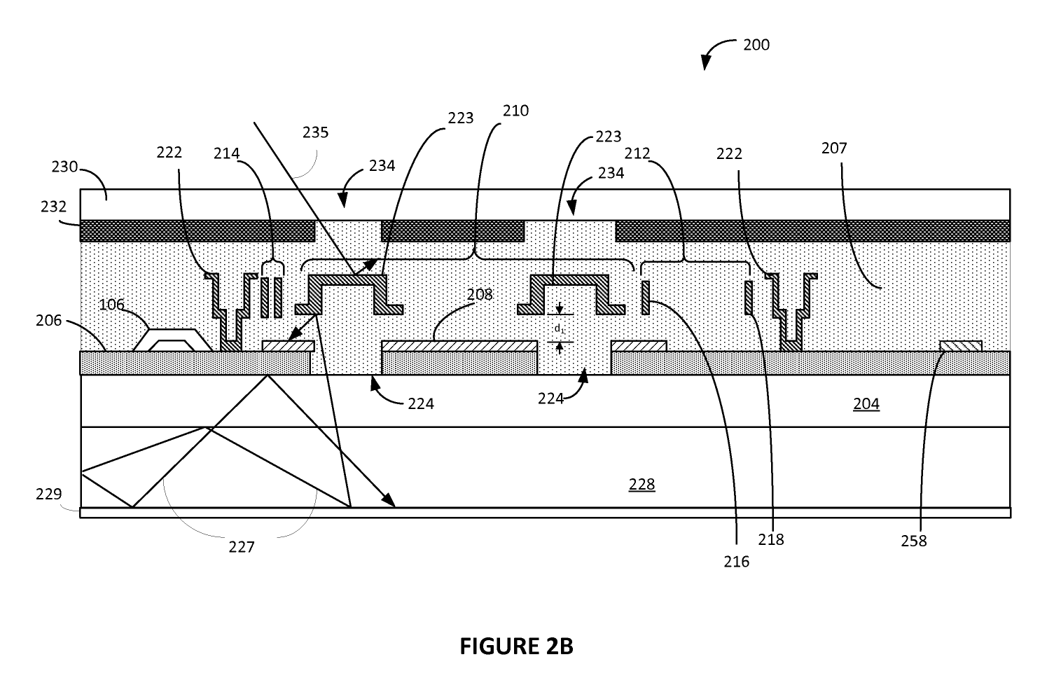

FIG. 2A shows a plan view of a portion of an example display apparatus 200. FIG. 2B shows a cross-sectional view of a portion of the display apparatus 200 taken across the line B-B′ shown in FIG. 2A. Referring to FIGS. 2A and 2B, the display apparatus 200 includes a display region 201 surrounded by a periphery 203. The periphery 203 includes a polymer seal 205 that encloses the display region 201. The periphery 203 may also include additional electronic components, similar to the controller 134, scan drivers 130, data drivers 132, and common drivers 138. The electronic components can be formed as separate integrated circuits bonded to the display apparatus in a chip-on-glass (COG) configuration. In some other implementations, the periphery 203 includes cable ports to which similar electronics interface with the display apparatus 200 via flex cables or the like.

Within the display region 201, the display apparatus 200 includes an array of shutter-based light modulators 202, two of which are shown in FIG. 2A. The shutter-based light modulators 202 are fabricated over two light blocking layers disposed over an underlying substrate 204 (shown in FIG. 2B). The two light blocking layers include a light reflecting layer 206 and a light absorbing layer 208. The shutter-based light modulators 202 are controlled by circuit elements formed over the substrate 204 and beneath the array of shutter-based light modulators 202. The circuit elements are formed primarily in regions that lie between the individual shutter-based light modulators 202 in the array. The collection of circuit elements that controls the state of the shutter-based light modulators 202 is referred to herein as a control matrix. The elements of the control matrix will be more pointed out more specifically below.

Each shutter-based light modulator 202 includes a shutter 210, a shutter-open actuator 212, and a shutter-close actuator 214. Each shutter-open actuator 212 and shutter-close actuator 214 includes two compliant beams that form opposing electrodes of an electrostatic actuator. A first beam, referred to as a load beam 216 couples directly to the shutter 210. A second beam, referred to as the drive beam 218, is positioned adjacent the load beam 216. When a voltage is applied across the load beam 216 and the drive beam 218, the beams are drawn together moving the shutter 210 in a plane substantially parallel to the substrate 204.

Each shutter-based light modulator 202 also includes a pair of load anchors 220 and a pair of drive anchors 222. The load anchors 220 support the load beams 216 and the shutter 210 over the substrate 204. The load beams support the shutter 210 a first distance d₁ over the light absorbing layer 208. In some implementations, d₁ is between about 2 and about 5 microns. In some implementations, d₁ is about 4 microns. The drive anchors 222 support the drive beams 218 over the substrate 204 such that they are substantially the same height over the light absorbing layer 208 as the load beams 216. The load anchors 220 and the drive anchors 222 also couple the shutter 210, the load beams 216, and the drive beams 218 to corresponding portions of the control matrix, as described further below.

Each shutter 210 also includes a pair of protrusions 223. The protrusions provide the shutter 210 with additional rigidity. They also trap light rebounding off of the shutter 210 when the shutter 210 is in the closed position.

As indicated above, the shutter-open actuator 212 and shutter-close actuator 214 move the shutter 210 in a plane that is substantially parallel to the substrate 204. More particularly, the shutter-open actuator 212 and shutter-close actuator 214 impart translational movement upon the shutter 210 relative to apertures 224 defined through the reflective layer 206 and the light absorbing layer 208. As shown in FIGS. 2A and 2B, the reflective layer 206 and the light absorbing layer 208 include two apertures 224 for each shutter-based light modulator 202. Accordingly, each shutter 210 includes a shutter aperture 226 defined through it. When the shutter-open actuator 212 moves the shutter 210 into an open or light transmissive state (as represented by the left-hand shutter-based light modulator 202 shown in FIG. 2A), the shutter aperture 226 aligns with one of the apertures 224 defined through the reflective layer 206 and the light absorbing layer 208, such that light 227 from a backlight 228 (shown in FIG. 2B) can pass through the aperture 224 and through the shutter aperture 226. In the open state, the shutter 210 is positioned such that the other aperture 224 is positioned beyond the outer edge of the shutter 210, allowing light passing through the other aperture 224 to pass beside the shutter 210. In the closed state (as represented by the right-hand shutter based light modulator 202 shown in FIG. 2A and the shutter-based light modulator 202 shown in FIG. 2B), the shutter-close actuator 214 moves the shutter 210 into a position in which the shutter 210 blocks substantially all of the light passing through the apertures 224. In other implementations, the shutter 210 can be configured to modulate light passing through only one, or more than two, apertures 224.

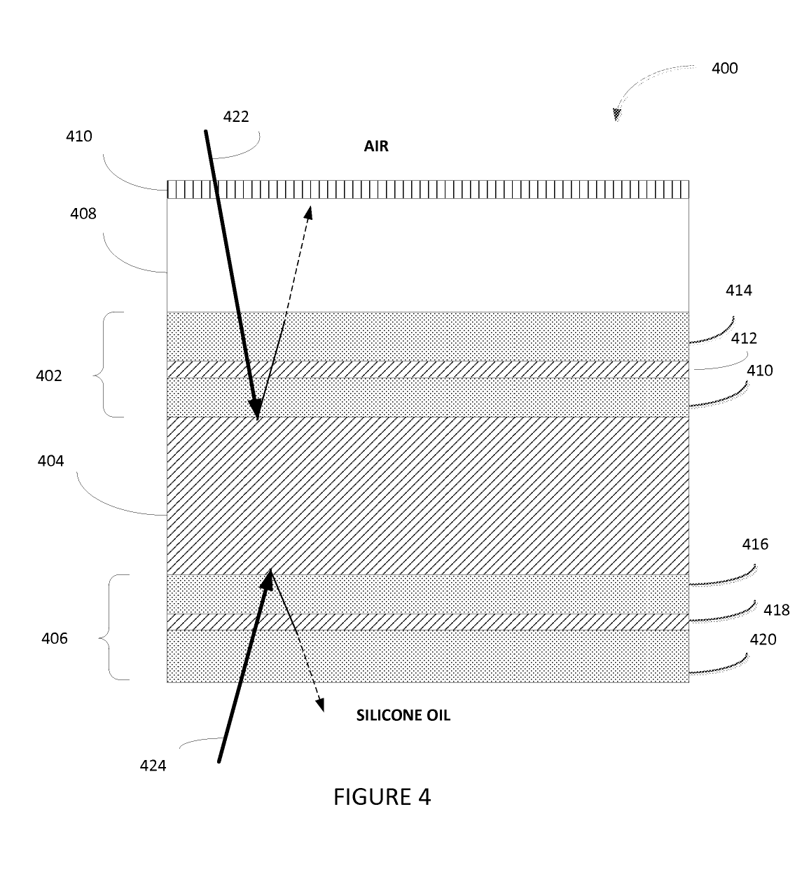

As shown in FIG. 2B, the display apparatus 200 also includes a coversheet 230 that forms the front surface of the display apparatus 200. A front aperture layer 232 is disposed on the rear surface of the cover sheet 230. The front aperture layer 232 includes a set of apertures 234 defined through it. Each of the apertures 234 defined in the front aperture layer 232 corresponds to and is substantially aligned with an aperture 224 formed through the reflective layer 206 and the light absorbing layer 208. In some implementations, an anti-reflective coating (not shown) is applied to the front surface of the coversheet 230. The front aperture layer 232 helps absorb ambient light 235 impinging on the front surface of the coversheet 230. It also helps absorb stray light rebounding between the substrate 204 and the coversheet 230. In some implementations, the front aperture layer 232 is formed from a resin black matrix, in which light absorbing particles are suspended in a polymer resin. In some other implementations, the front aperture layer 232 is formed from other materials, such as cermets, or a stack of materials including alternating layers of a metal and a semiconductor, a metal and a conductor, or a metal and a dielectric material. One particular example of a front aperture layer 232 is shown in FIG. 4.

In some implementations, the space between the coversheet 230 and the substrate 204 is filled with a fluid, such as a liquid lubricant 207. In some implementations, the liquid lubricant can be a silicone oil. In some other implementations, the space can be filled with other fluids, such as air.

Referring back to FIG. 2A, as set forth above, the display apparatus 200 includes a control matrix fabricated over the substrate 204. In some implementations, the control matrix is fabricated over the reflective layer 206. In such implementations, the reflective layer 206 is formed from a non-conductive material, such as a dielectric mirror. The reflective layer 206 reflects light exiting from the backlight 228 that does not pass through an aperture 224 back into the backlight 228. A front-facing reflective layer 229 (shown in FIG. 2B) is positioned at the rear of the backlight 228 and reflects light back towards the reflective layer 206. Both the reflective layer 206 and the front-facing reflective layer are formed to have a high level of reflectance. In some implementations, the reflectance of both layers is between about 75% and about 99.9%. In some implementations, the reflectance of both layers is at least about 95%. Given the limited aperture ratio of the display apparatus 200, the high-efficiency reflection of light between the reflective layer 206 and the front-facing reflective layer 229 substantially increases the output efficiency of the backlight 228 by “recycling” light that exits the backlight 228 but that does not pass through one of the apertures 224. As part of reflecting light back to the backlight 228, the reflective layer 206 blocks light emitted backlight 228 from passing through the display other than through the apertures 224 formed in the reflective layer 206.

The control matrix shown in FIG. 2A includes interconnects that couple to multiple shutter-based light modulators 202 and electrical components and interconnects that are dedicated to controlling a particular shutter-based light modulator 202 (referred to as pixel circuits). More particularly, the control matrix includes a plurality of scan-line interconnects 250, each of which couples to multiple shutter-based light modulators 202 in a given row of the display apparatus 200, and a plurality of a data interconnects 252, each of which couples to multiple shutter-based light modulators 202 in a given column of the display apparatus 200. The control matrix also includes an actuation voltage interconnect 254, a global actuation interconnect 256, a common drive interconnect 258, and a reference voltage interconnect 260, each of which couple to shutter-based light modulators 202 in multiple rows and multiple columns of the display apparatus. For a given shutter-based light modulator 202, a pixel circuit includes a write-enabling transistor 262, a data storage capacitor 264, a charge transistor 266, and a discharge transistor 268. The transistors can be thin-film transistors (TFTs), such as amorphous silicon (a-Si), low-temperature polysilicon (LTPS), or conductive oxide (such as indium gallium zinc oxide (IGZO)) transistors.

A row of shutter-based light modulators 202 are addressed by applying a voltage to a corresponding scan-line interconnect 250 and applying data voltages to the data interconnects 252 associated with each column of shutter-based light modulators 202 in the display apparatus 200. The voltage applied to the scan-line interconnect 250 turns ON the write-enabling transistors 262 of the pixel circuits coupled to the scan line interconnect 250. For a given pixel circuit, the data voltage applied to a corresponding data interconnect 252 passes through the write-enabling transistor 262 and is stored on the data storage capacitor 264.

After data is stored on all of the shutter-based light modulators 202, all of the shutter-based light modulators 202 are driven into a first state (such as the open state) through the application of an actuation voltage to the actuation voltage interconnect 254. The actuation voltage turns the charge transistor 266 in each pixel circuit ON, storing an actuation voltage on the drive beam 218 of the shutter-open actuator 212 of the shutter-based light modulators 202 coupled to the pixel circuit via a corresponding drive anchor 222, thereby moving the shutter 210 of the shutter-based light modulator 202 into the first state.

The voltage on the global actuation interconnect 256 is then lowered. As a result, at each pixel circuit, the discharge transistor 268 is able to respond to the data voltage stored on its respective data storage capacitor 264, thereby selectively retaining or discharging the voltage stored on the drive beam 218 of its shutter-open actuator 212. An actuation voltage is then applied to the common drive interconnect 258, storing a voltage on the drive beam 218 of the shutter-close actuator 214, via its drive anchor 222, of each shutter-based light modulator 202. Any shutter 210 which is no longer held in the first state by an actuation voltage stored on the drive beam 218 of its corresponding shutter-open actuator 212 is drawn by the voltage on its corresponding shutter close actuator 214 into a second state (such as the closed state). In some other implementations, the pixel circuits and shutter-based light modulators 202 are instead configured such the first state is a closed state and the second state is an open state.

As indicated above, the control matrix can be fabricated over the reflective layer 206 of the display apparatus 200. In some implementations, the reflective layer 206 extends substantially across the entire display region of the display apparatus 200 other than at the apertures 224 defined through it. In some implementations, the percentage of the substrate 204 covered by the light absorbing layer 208, however, is more constrained. In some such implementations, the light absorbing layer 208 is formed from materials that are conductive, such as metals and/or semiconductors. This is in part because many non-conductive, light absorbing materials, such as low melting point polymers used in typical resin black matrices, are difficult, and in some cases completely impractical, to use as the light absorbing layer 208 due to the high temperatures the light absorbing layer 208 is exposed to during the formation of the control matrix. Being formed from conductive materials, were the light absorbing layer 208 to cover substantially the entire display region of the display apparatus 200, similar to the reflective layer 206, the light absorbing layer 208 would end up extending above or below large portions of the control matrix, leading to substantial parasitic capacitance between components of the control matrix and the light absorbing layer 208. This in turn would significantly increase the power needed to address and actuate the shutter-based light modulators 202 of the display apparatus 200. While low melting point polymers (or other non-conductive light absorbing materials) may be less suited for inclusion in the light absorbing layer 208, they may still be useful for incorporation into the front aperture layer 232, which is not exposed to such high temperatures during its manufacture.

Accordingly, in some implementations, the light absorbing layer 208 is constrained to regions surrounding the apertures 224 formed through the reflective layer 206 and the light absorbing layer 208. The light absorbing layer 208 extends far enough away from the apertures 224 such that substantially all of the light that might reflect off of the under side of the shutters 210 either passes back through the apertures 224 or impinges on a portion of the light absorbing layer 208. Were this light instead to impinge on the reflective layer 206, it could rebound back towards the front, and out of, the display apparatus 200, reducing the contrast ratio of the display apparatus 200.

Accordingly, the degree to which the light absorbing layer 208 extends around the apertures 224 depends on how far light passing through the apertures 224 could travel from the edge of the apertures after reflecting off the underside of the shutter 210. This rebound distance is a function, in part, of the distance d₁, mentioned above, between the light absorbing layer 208 and the shutter 210. The rebound distance is also based on the other optical properties of the materials used in forming the display apparatus 200, the presence of any fluids that may be trapped between the substrate 204 and the cover sheet 230, and the critical angle of the light guide of the backlight 228, which together dictate the range of angles of light that may pass through the apertures 224. In some implementations, for example, the display apparatus 200 is configured such that light can only pass through the apertures 224 at angles less than or equal to about 45° of the display normal. Thus, in some implementations, the light absorbing layer 208 may only extend away from the aperture 224 sufficiently far to reliably block light that passes through the apertures 224 and reflects off of a shutter 210 at angles of about 45° of the display normal or less.

In some implementations, the light absorbing layer 208 extends away from the apertures 224 a distance of about three times the distance d₁. In some other implementations, the light absorbing layer 208 extends away from the apertures 224 a distance of about five times the distance d₁. For example, the light absorbing layer 208 may extend between about 9 microns and about 20 microns outward from the apertures. In some implementations, the expanse of the light absorbing layer 208 is constrained such that it does not lie beneath the drive beams 218 of the shutter-open or shutter-close actuators 212 and 214. In some implementations, the expanse of the light absorbing layer 208 is constrained such that it does not cover, or lie beneath any interconnects that couple to multiple shutter based light modulators 202, such as the scan-line interconnects 250 or the data interconnects 252.

In some implementations, the light absorbing layer 208 is constrained to a region around the apertures 224 such that it extends on top of or beneath less than a majority of the “footprint” of the circuitry of the control matrix. In some implementations, the light absorbing layer 208 is constrained to a region around the apertures 224 such that it extends on top of or beneath less than about 25% of the “footprint” of the circuitry of the control matrix.

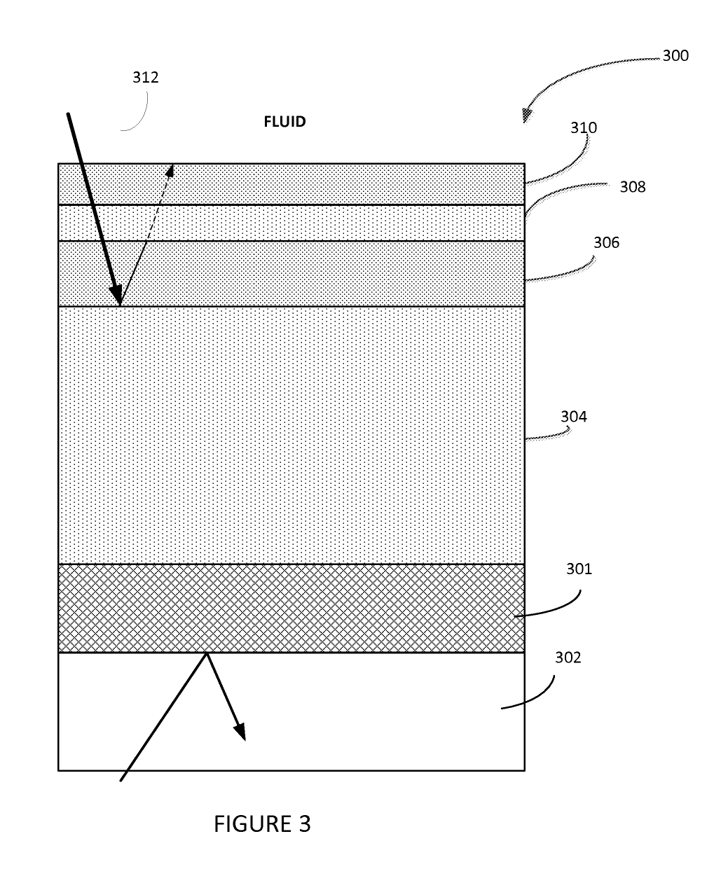

FIG. 3 is a cross sectional view of an example one-sided light absorbing material stack 300. The light absorbing material stack 300 is an example of a stack of materials suitable for use as the light absorbing layer 208 shown in FIGS. 2A and 2B. As shown in FIG. 3, the light absorbing material stack 300 is disposed over a reflective layer 301, such as the reflective layer 206 (shown in FIG. 2B), which, in turn, is disposed over a substrate 302, such as the substrate 204 (shown in FIG. 2B). The light absorbing material stack 300 includes alternating layers of a semiconductor material and metal. More particularly, the light absorbing material stack 300 includes a lower metal layer 304, a lower semiconductor layer 306, an upper metal layer 308, and an upper semiconductor layer 310. The light absorbing material stack 300 absorbs light through direct absorption within the materials. The total light reflected by the material stack 300 is further reduced through destructive interference between the light entering the light absorbing material stack 300 and light reflecting off of the lower metal layer 304.

One example semiconductor suitable for use in the lower and upper semiconductor layers 306 and 310 is a-Si. Other suitable semiconductors include other forms of Si, including single-crystal Si, polycrystalline Si, or combinations thereof, germanium (Ge), and other Group 4 elements. The lower and upper semiconductor layers 306 and 310, in some implementations, are each less than about 50 nm thick. In some implementations, one or both of the lower and upper semiconductor layers 306 and 310 can be replaced with a layer of conductive material, such as indium tin oxide (ITO) and other conductive oxides. In such implementations, the thickness of the ITO layer can be less than about 200 nm, less than about 100 nm or less than about 70 nm. In some other implementations, one or more of the semiconductor layers 307 can be replaced with a high refractive index dielectric layer that is or that includes a high refractive index dielectric material. Examples of such dielectric materials include silicon nitride (SiNx) and titanium dioxide (TiO₂). In some such implementations, the thickness of the high refractive index dielectric layer can be less than about 300 nm, less than about 200 nm or less than about 100 nm.

Suitable metals for the lower and upper metal layers 304 and 308 include, without limitations, aluminum (Al), titanium (Ti), molybdenum (Mo), and Mo-containing alloys. In some implementations, the thickness of the upper metal layer 308 can be less than about 50 nm, less than about 30 nm, less than about 25 nm, less than about 15 nm, less than about 10 nm or less than about 1 nm.

In some implementations, the lower metal layer 304, i.e., the layer deposited on the reflective layer 301, is formed to be substantially thicker than the upper metal layer 308. For example, the lower metal layer 304, in some implementations, is formed from a layer of Al which is on the order of several hundred nanometers thick. In general, the lower metal layer 304 is formed to be thick enough to reflect a substantial portion of light that passes through the layers above it in the light absorbing material stack 300.

In one particular implementation, the lower metal layer 304 is formed from a 200 nm thick layer of Al. The lower metal layer 304 is coated with the lower semiconductor layer 306, formed from a 38 nm thick layer of a-Si layer. This layer is coated with the upper metal layer 308, which is formed from a 17 nm thick layer of Al. The upper metal layer 308 is coated by the upper semiconductor layer 310, which is formed from a 20 nm thick layer a-Si. The light absorbing material stack 300 is covered by a silicone oil. In such a configuration, the light absorbing material stack 300 has a reflectance of only about 2%.

FIG. 4 shows a cross sectional view of an example two-sided light absorbing layer 400. The two-sided light absorbing layer 400 is configured to absorb light impinging on both of its front facing and rear-facing surfaces. Thus, the two-sided light absorbing layer 400 is an example of a light absorbing structure suitable for use as the front aperture layer 232 shown in FIG. 2B. Used as such, the two-sided light absorbing layer 400 can absorb ambient light 422 impinging on the front surface of the display apparatus 200, as well as absorbing stray light 424 reflecting off of various surfaces between the substrate 204 and the cover sheet 230 of the display apparatus.

In general, the two-sided light absorbing layer 400 includes a front-facing set of alternating layers 402, an inner metal layer 404, and a rear-facing set of alternating layers 406. The two sided light absorbing layer 400 is fabricated on a first face of a transparent substrate 408, formed, for example, from glass. In some implementations, the second face of the substrate 408 is coated with an anti-reflective coating 410.

The front-facing set of alternating layers 402 and the rear-facing set of alternating layers 406 both include alternating layers of a dielectric material and a metal. The layers of dielectric material, in some implementations, are each less than 100 nm thick, less than 75 nm thick, or less than 50 nm thick. The layer(s) of metal are each less than about 50 nm thick, less than 25 nm thick, or less than or equal to about 15 nm thick.

In some implementations, the layers of dielectric material are formed from SiNx, or other high refractive index dielectric materials, such as TiO₂. In some implementations, one or more of the layers of dielectric material can be replaced with a layer of conductive material, such as indium tin oxide (ITO), or any of the semiconducting materials described above.

In some implementations, the metal layers included in the front-facing set of alternating layers 402 and the rear-facing set of alternating layers 406 are formed from a generally light absorbing metal or metal alloy, such as Mo or Molybdenum Tungsten (MoW). In other implementations, other metals, such as Al or Ti could be used instead. The inner metal layer 404 is formed from a metal layer that is substantially thicker than the metal layers in the front-facing set of alternating layers 402 and the rear-facing set of alternating layers 406. In general, the metals included in the front-facing set of alternating layers 402 and the rear-facing set of alternating layers 406 are formed into layers that are thin enough to be substantially transparent, whereas the inner metal layer is thick enough to be substantially opaque.

In some implementations, the front-facing set of alternating layers 402 includes a first front dielectric layer 410, a front metal layer 412, and a second front dielectric material 414, and the rear-facing set of alternating layers 402 includes a first rear dielectric layer 416, a rear metal layer 418, and a second rear dielectric layer 420. In one particular implementation, the first front dielectric layer 410 and the first rear dielectric layer 416 are formed from layers of SiNx that are about 40 nm thick. The front and rear metal layers 412 and 418 are formed layers of MoW that are about 40 nm thick. The second front and second rear dielectric layers 414 and 420 are formed from layers of SiNx that are about 60 nm thick. When formed on a glass substrate 408 and covered by silicone oil, the above described structure can have a reflectance through the glass substrate 408 of only about 0.03% and through the silicone oil of about 0.2%.

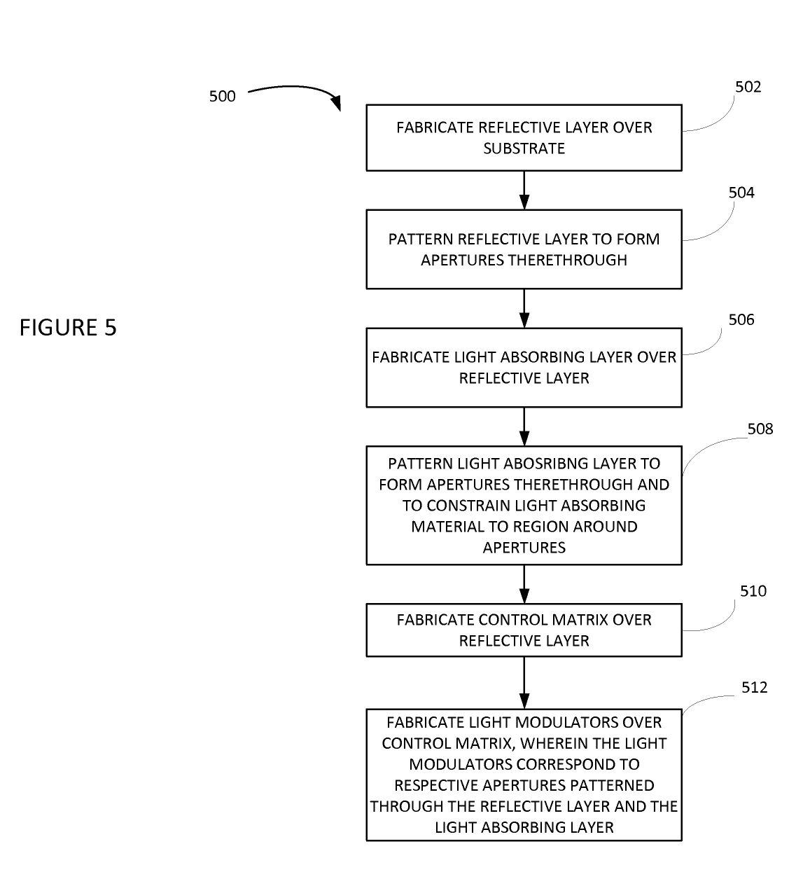

FIG. 5 shows a block diagram of an example method of manufacturing a display apparatus 500. For example, the method 500 is one example method suitable for fabricating portions of the display apparatus 200 shown in FIGS. 2A and 2B. In brief overview, the method includes fabricating a reflective layer over a substrate (stage 502), patterning the reflective layer to form apertures therethrough (stage 504), fabricating a light absorbing layer over the reflective layer (stage 506), and patterning the light absorbing layer to form apertures therethrough and to constrain the light absorbing material therein to regions around the apertures (stage 508). The method further includes fabricating a control matrix over the reflective layer (stage 510) and fabricating light modulators over the control matrix (stage 512), where the light modulators correspond to respective apertures patterned through the reflective layer and the light absorbing layer.

More particularly, the method 500 begins with the fabrication of a reflective layer over a substrate (stage 502). The substrate, in some implementations is transparent, and formed from a material having properties suitable for thin-film circuit processing, such as glass. In some implementations, the reflective layer is fabricated to be non-conductive. For example, it can be fabricated as a dielectric mirror. As would be known to a person of ordinary skill in the art, a dielectric mirror can be fabricated by depositing alternating layers of dielectric materials having different indices of refraction. The layers of dielectric material can be deposited using various thin film deposition techniques, such as chemical vapor deposition (CVD), atomic layer deposition (ALD) or spin-on techniques. Since the reflective layer is non-conductive, it can be deposited over substantially the entire surface of the substrate.

Subsequently, apertures are patterned through the reflective layer (stage 504). The apertures can be formed using a variety of photo lithographic processes, including wet etching or reactive ion etching. The position of the apertures can be defined by the application and photo-patterning of a resist layer on top of the reflective layer. The apertures can serve, for example, as the apertures 224 defined through the reflective layer 206 shown in FIGS. 2A and 2B.

A light absorbing layer is deposited over the reflective layer (stage 506). The light absorbing material stack 300 shown in FIG. 3 is one example structure suitable for use as the light absorbing layer. The various layers of the light absorbing material stack can be deposited sequentially using various techniques, depending on the specific materials selected and their desired thicknesses. Suitable deposition techniques include, for example, CVD, plasma enhanced chemical vapor deposition (PECVD), and ALD.

In some implementations, the light absorbing layer is deposited directly on top of the reflective layer. In some other implementations, the light absorbing layer is deposited over the reflective layer and one or more intervening metal and/or dielectric layers. In some such implementations, the light absorbing layer is deposited as a portion of the control matrix, or on top of the control matrix. For example, the light absorbing layer, given its conductivity, can serve as the bottom metal, or M1, layer of the control matrix. In other implementations it can serve as an upper layer, for the example the third, or M3, metal layer.

After its deposition, the light absorbing layer is patterned (stage 508). In some implementations, it is patterned to achieve two results: to etch apertures through the light absorbing layer in alignment with the apertures patterned through the reflective layer, and to constrain the extent to which the light absorbing layer extends above or below the control matrix. As indicated above in relation to FIGS. 2A and 2B, in some implementations, the light absorbing layer is patterned such that the light absorbing material that forms the layer is constrained to within a desired distance extending outward from the apertures defined therethrough. For example, in some implementations, the light absorbing layer is patterned such that it extends away from the apertures by no more than between about two or three times and about five times the distance separating the upper most surface of light absorbing layer and the underside of a shutter fabricated over the light absorbing layer. In some other implementations, the light absorbing layer is patterned such that it does not extend above or below the majority, or in some cases more than about 25%, of the material that makes up the control matrix (not including any of the material from the light absorbing layer that is also used as part of the control matrix). The light absorbing layer can be patterned using a variety of photolithographic processes, including a variety of wet and dry etching techniques known to persons of ordinary skill in the art.

As indicated above, the method also includes the fabrication of a control matrix over the reflective layer (stage 510). One example control matrix architecture is described above in relation to FIG. 2A. In other implementations, a wide variety of alternative control matrices can be employed.

Depending on the particular implementation, the control matrix may be fabricated over both the reflective layer and the light absorbing layer. As suggested above, in some other implementations, the light absorbing layer may be fabricated as part of, or on top of, the control matrix. The control matrix can be fabricated using a variety of thin-film circuit fabrication processes, including processes suitable for the formation of a-Si, low-temperature polysilicon (LTPS), or conductive oxide (such as IGZO) based transistors.

After the control matrix is fabricated at stage 510, a plurality of light modulators are fabricated over and in electrical communication with the control matrix (stage 512). In some implementations, the light modulators are electromechanical systems (EMS)-based light modulators, such as nanoelectromechanical systems (NEMS), microelectromechanical (MEMS) or larger scale light modulators. One example light modulator architecture suitable for fabrication in the method 500 is shown in FIGS. 2A and 2B. In other implementations, other light modulators, such as electrowetting or liquid crystal-based light modulators may be fabricated over the control matrix.

As indicated above, the shutter-based light modulators 202 shown in FIGS. 2A and 2B are suitable for fabrication as part of stage 512 of the method 500. The shutter-based light modulators can be fabricated through a series of thin-film MEMS fabrication stages. In general, such shutter-based light modulators can be fabricated by first forming a mold out of one or more layers of sacrificial material, each between about 2 microns and about 5 microns thick. The layers of sacrificial material can be formed from photoresist. Alternatively, the layers of sacrificial material can be fabricated from other known sacrificial materials that are patterned using various etch or lift-off processes. One or more layers of structural material are then deposited over the mold, and are etched using one or more isotropic and/or anisotropic etches to define the structures that make up the shutter-based light modulators, including the anchors, actuators, and shutters included in the light modulators. The layers of structural material can include one or more layers of metal (such as Al or Ti) and/or semiconductors (such as a-si, polysilicon, or single crystal Si). Such layers are deposited to an aggregate thickness of less than about 2 microns. The light modulators are then released through a process that removes the sacrificial layer mold.

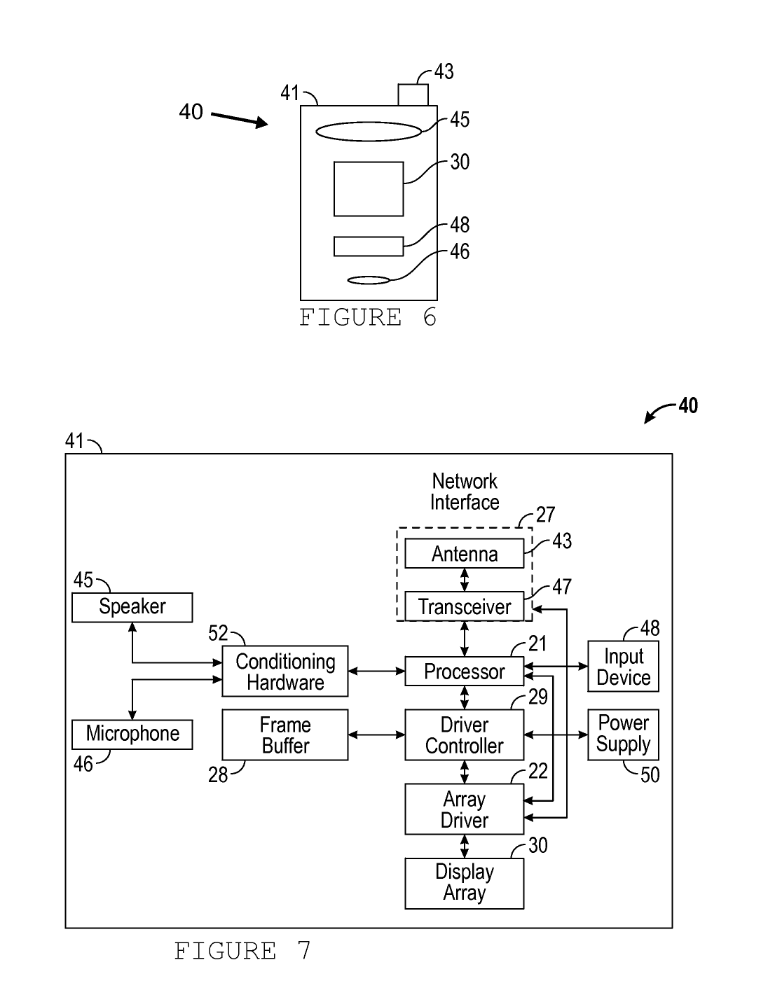

FIGS. 6 and 7 show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 6. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 6, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a substrate including a display region and a periphery;
a plurality of display elements arranged across the display region of the substrate, wherein each display element includes at least one movable component supported a first distance over the substrate, the movement of which is controlled in part by a respective switch coupled to the substrate; and
a light blocking layer disposed between the display elements and the substrate defining a plurality of apertures therethrough, the light blocking layer including a light absorbing layer patterned such that it substantially surrounds each of the apertures by a width that is greater than or about equal to the first distance and less than about 5 times the first distance.

2. The apparatus of claim 1, wherein the light blocking layer further includes a non-conductive light reflecting layer extending across substantially the entirety of display region other than at the apertures defined through the light blocking layer.

3. The apparatus of claim 2, wherein the non-conductive light reflecting layer includes a dielectric mirror.

4. The apparatus of claim 1, wherein the light absorbing layer includes at least one layer of conductive material.

5. The apparatus of claim 4, wherein the light absorbing layer is absent above and below the switch.

6. The apparatus of claim 4, wherein the light absorbing layer includes a multi-layer stack of a metal and one of a semiconductor and a dielectric.

7. The apparatus of claim 6, wherein the multi-layer stack includes at least one layer of a semiconductor having a thickness of less than about 50 nm.

8. The apparatus of claim 7, wherein the multi-layer stack includes at least one layer of metal having a thickness of less than about 50 nm.

9. The apparatus of claim 4, wherein the light absorbing layer includes a first set of layers configured to absorb light incident on an external face of the substrate and a second set of layers configured to absorbing light incident on an internal face of the substrate.

10. The apparatus of claim 9, wherein the light absorbing layer includes layers of a metal and a dielectric, each having thicknesses of less than about 100 nm, on either side of a layer of metal having a thickness of greater than about 100 nm.

11. The apparatus of claim 1, further comprising a coversheet coupled to the substrate along the periphery of the substrate, and wherein the coversheet forms the front of the apparatus.

12. The apparatus of claim 1, comprising:
a display including the plurality of display elements;
a processor that is configured to communicate with the display, the processor being configured to process image data; and
a memory device that is configured to communicate with the processor.

13. The apparatus of claim 12, further comprising:
a driver circuit configured to send at least one signal to the display; and wherein the processor is further configured to send at least a portion of the image data to the driver circuit.

14. The apparatus of claim 12, further comprising:
an image source module configured to send the image data to the processor, wherein the image source module comprises at least one of a receiver, transceiver, and transmitter.

15. The apparatus of claim 12, further comprising:
an input device configured to receive input data and to communicate the input data to the processor.

16. An apparatus comprising:
a substrate including a display region and a periphery;
a plurality of display elements arranged across the display region of the substrate, wherein each display element includes at least one movable component supported over the substrate, the movement of which is controlled in part by circuitry coupled to the substrate;
a light blocking layer disposed between the display element and the substrate defining a plurality of apertures therethrough, the light blocking layer including:
a non-conductive light reflecting layer covering substantially the entirety of the display region of the substrate other than at the apertures defined through the light blocking layer; and
a light absorbing layer patterned such that it substantially surrounds each of the apertures defined through the light blocking layer, but is absent between the substrate and the majority of the circuitry.

17. The apparatus of claim 1, wherein the movable components of the display elements are supported a first distance over the light blocking layer, and wherein the light absorbing layer has a width around each of the apertures which is greater than or about equal to the first distance.

18. The apparatus of claim 2, wherein the width is less than about five times the first distance.

19. The apparatus of claim 1, wherein the non-conductive light reflecting layer includes a dielectric mirror.

20. The apparatus of claim 1, wherein the light absorbing layer includes a conductive material.

21. The apparatus of claim 1, wherein the light absorbing layer includes a multi-layer stack of a metal and one of a semiconductor and a dielectric.

22. The apparatus of claim 1, wherein the circuitry includes at least one thin-film transistor for each display element.

23. A method of manufacturing comprising:
fabricating a reflective layer over a substrate;
patterning the reflective layer to form apertures therethrough;
fabricating a light absorbing layer over the reflective layer;
patterning the light absorbing layer to form apertures therethrough and to constrain the light absorbing material to regions around the apertures;
fabricating a control matrix over the reflective layer; and
fabricating a plurality of light modulators over the control matrix, wherein the light modulators correspond to respective apertures patterned through the reflective layer and the light absorbing layer.

24. The method of claim 19, wherein the light modulators are separated from a front-facing surface of the light absorbing layer by a first distance and wherein the region the light absorbing material is constrained to extends less than about five times the first distance from the respective apertures.

25. The method of claim 19, wherein the reflective layer is fabricated to be non-conductive.

26. The method of claim 19, wherein the light absorbing layer is fabricated from a plurality of layers of material, including at least one conductive material.

27. The method of claim 19, wherein the control matrix is fabricated substantially outside of the region to which the light absorbing material is constrained.
